(19) United States
(12) Patent Application Publication
(10) Pub. No.: US 2016/0253484 A1
(43) Pub. Date: Sep. 1, 2016

(54) RANKING FRAUD DETECTION FOR APPLICATION

(71) Applicant: BEIJING ZHIGU RUI TUO TECH CO., LTD., Beijing (CN)

(72) Inventors: Hengshu Zhu, Beijing (CN); Kuifei Yu, Beijing (CN)

(73) Assignee: BEIJING ZHIGU RUI TUO TECH CO., LTD, Beijing (CN)

(21) Appl. No.: 15/028,015

(22) PCT Filed: Oct. 9, 2014
(86) PCT No.: PCT/CN2014/088245

§ 371 Date: Apr. 7, 2016

(30) Foreign Application Priority Data
Oct. 10, 2013 (CN) 201310469985.8

(51) Int. Cl. G06F 21/12; G06F 17/30

(52) U.S. Cl. CPC G06F 21/12; G06F 17/3053

(57) ABSTRACT

The present application provides a ranking fraud detection method and a ranking fraud detection system for an application. The method comprises: a leading session detection step: detecting a leading session of the application based on historical ranking information; and a ranking fraud detection step: detecting the leading session based on at least one piece of evidence, to obtain a ranking fraud detection result. According to the method and the system of the present application, a ranking fraud act related to an application can be automatically identified, thereby allowing an application user to obtain real application ranking information.

### RELATED APPLICATION

The present international patent cooperative treaty (PCT) application claims the benefit of priority to Chinese Patent Application No. 201310469985.8, filed on Oct. 10, 2013, and entitled “Ranking Fraud Detection Method and Ranking Fraud Detection System for Application”, which is hereby incorporated into the present international PCT application by reference herein in its entirety.

### TECHNICAL FIELD

The present application relates to the field of networks, and in particular, to ranking fraud detection for an application.

### BACKGROUND

User applications especially mobile applications installed and running on mobile terminals have developed rapidly in recent years. In order to facilitate application selection and installation by users, many application websites or application stores will intensively provide query, download, user rating or commenting and other services for the applications, and may also regularly, for example, daily, release an application leaderboard to reflect some applications currently popular with the users. In fact, the leaderboard is one of the most important means for application promotion, an application ranking high on the leaderboard usually excites the users to download the application in large quantities, and brings about huge economic benefits to application developers. Therefore, the application developers want their applications to rank high on the leaderboard.

Ranking fraud of an application refers to a deceptive act performed aimed at improving a ranking of the application on an application leaderboard. In fact, different from improving a ranking of an application by relying on a conventional market means, implementing a ranking fraud act by an application developer by exaggerating product sales of the application developer or releasing false product ratings has become increasingly prevalent, for example, “human water armies” are hired to improve downloads, a rating frequency and the like of an application in a short time.

The industry has realized the importance of preventing ranking fraud from allowing an application user to obtain real application ranking information. In order to prevent ranking fraud of an application, an existing method is to infer existence of a ranking fraud act according to the degree of raising of a ranking of the application in one day, and directly lock the ranking of the entire application when it is determined that ranking fraud occurs; such a manner is excessively simple and crude, and it is difficult to accurately determine the ranking fraud act, and is also harmful to raise a ranking of a normal application. It can be seen that, in the art, understanding of and researching on application ranking fraud detection issues are still very limited, and related technologies for effectively detecting application ranking fraud have not existed yet.

### SUMMARY

An objective of the present application is to provide a ranking fraud detection technology for an application, so as to automatically and effectively identify a ranking fraud act related to the application, thereby allowing an application user to obtain real application ranking information.

According to one aspect of the present application, a ranking fraud detection method for an application is provided, wherein the method comprises:

a leading session detection step: detecting a leading session of the application based on historical ranking information; and
a ranking fraud detection step: detecting the leading session based on at least one piece of evidence, to obtain a ranking fraud detection result.

According to another aspect of the present application, a ranking fraud detection system for an application is further provided, wherein the system comprises:

a leading session detection unit, configured to detect a leading session of the application based on historical ranking information; and
a ranking fraud detection unit, configured to detect the leading session based on at least one piece of evidence, to obtain a ranking fraud detection result.

According to another aspect of the present application, a ranking fraud detection method for an application is further provided, wherein the method comprises: detecting a leading session of the application based on at least one piece of evidence, to obtain a ranking fraud detection result.

According to another aspect of the present application, a ranking fraud detection system for an application is further provided, wherein the system comprises:

a ranking fraud detection unit, configured to detect a leading session of the application based on at least one piece of evidence, to obtain a ranking fraud detection result.

According to the methods and the systems of the present application, a ranking fraud act related to an application can be automatically and effectively identified, thereby allowing an application user to obtain real application ranking information.

### BRIEF DESCRIPTION OF THE DRAWINGS

FIG. 1 is a flowchart of a method for detecting a leading session of an application in an embodiment of the present application;

FIG. 2a is an example of a leading event on an application leaderboard in an embodiment of the present application;

FIG. 2b is an example of a leading session on the application leaderboard in an embodiment of the present application;

FIG. 3 is a schematic diagram of different ranking phases in a leading event of an application in an embodiment of the present application;

FIG. 4a is a schematic diagram of a ranking record of an application suspected of having ranking fraud in an embodiment of the present application;

FIG. 4b is a schematic diagram of a ranking record of a normal application in an embodiment of the present application;

FIG. 5 is a schematic structural diagram of a ranking fraud detection system for an application in an embodiment of the present application; and

FIG. 6 is a schematic structural diagram of a ranking fraud detection system for an application in another embodiment of the present application.

### DETAILED DESCRIPTION

Embodiments of the present application are further described in detail below with reference to the accompanying drawings and the embodiments. The following embodiments are intended for describing the present application rather than limiting the scope of the present application.

The present application carries out research on technical problems related to application ranking; therefore, those skilled in the art should understand an “application” in the present application in a broad sense, which comprises various programs or files that can be released over the Internet and can be downloaded, rated and executed by a user, that is, comprises a conventional application running on a personal computer and a mobile application running on a mobile terminal, and also comprises an image, audio, video and other multimedia files that can be downloaded and played.

When ranking fraud of an application is detected, there are several issues that are presented. Firstly, ranking fraud may not occur all the time in the entire life cycle of the application, and therefore a date on which ranking fraud may occur is first detected; secondly, due to large quantities of applications, it is difficult to manually calibrate each application in which ranking fraud occurs, and therefore, in various embodiments, a technology is provided for automatically detecting ranking fraud; and thirdly, on what basis existence of ranking fraud is detected is not determined conventionally, and thus various embodiments herein address these issues.

In an embodiment of the present application, holistic analysis and research are carried out on an application ranking fraud act, and a technology that can detect ranking fraud of an application is provided, which can detect a “leading session” of the application by analyzing historical ranking information of the application, and detect ranking fraud based on at least one piece of evidence for a particular characteristic (comprising a ranking characteristic, a user rating characteristic, a user commenting characteristic, a leading user credibility characteristic, and the like) of the application in the leading session.

It is found according to the applicant's analysis that an application in which ranking fraud exists does not rank high on a leaderboard for a long time, high rankings intensively occur in a relatively short session only as some independent events, which indicates that a ranking fraud act just occurs in this session. In the present application, a session in which an application continuously ranks high may be referred to as a “leading event” of the application, and a session in which leading events occur frequently may be referred to as a “leading session” of the application. Therefore, for detecting ranking fraud, a leading event and a leading session in which ranking fraud may exist and in each application need to be first detected.

An application store operator owns historical ranking information of an application, and the historical ranking information of the application is directly acquired from the application store operator or may also be obtained by analyzing and processing application leaderboard information continuously released by the application store operator in a long historical session. As the historical ranking information of the application records historical information related to a ranking of the application, historical information related to a user rating of the application, historical information related to a user comment of the application, historical information related to user credibility of the application, and other types of information, in the embodiment of the present application, a leading event and a leading session of each application can be detected based on the historical ranking information, thereby detecting ranking fraud. It is found by analyzing a ranking act of an application that, compared with a normal application, an application in which ranking fraud exists may show different particular characteristics in a leading event and a leading session. Therefore, it is possible to extract some evidence used to determine ranking fraud from the historical ranking information of the application and acquire the evidence, thereby detecting ranking fraud.

As shown in FIG. 1, in an embodiment of the present application, a ranking fraud detection method for an application is provided, wherein the method comprises:

a leading session detection step S10: detecting a leading session of the application based on historical ranking information; and a ranking fraud detection step S20: detecting the leading session based on at least one piece of evidence, to obtain a ranking fraud detection result.

Processes and functions of the steps of the ranking fraud detection method in the embodiment of the present application are described below with reference to the accompanying drawings.

As the historical ranking information is a data basis for detecting application ranking fraud in the present application, as an exemplary embodiment of the present application, the ranking fraud detection method may further comprise a historical ranking information acquisition step: acquiring the historical ranking information of the application on an application leaderboard.

The application leaderboard may usually display popular applications ranking the top K, for example, the top 1000 or the like. Moreover, the application leaderboard may usually be updated regularly, for example, updated daily. Therefore, each application a has its historical ranking information, the historical ranking information may comprise one ranking index Rₐ={r₁^{a}, . . . , rᵢ^{a}, . . . , rₙ^{a}} corresponding to a discrete date index, and an interval between date points in the discrete date index is fixed, which is an update cycle of the application leaderboard. rᵢ^{a} indicates a ranking of the application a on a date tᵢ, rᵢ^{a}∈{1, . . . , K, . . . , +∞} and +∞ indicates that the application a does not rank the top K on the leaderboard; n indicates the total number of date points corresponding to all historical ranking information. For example, in a case in which the leaderboard is updated daily, tᵢ indicates the i^{th} day in the history, and n indicates the total number of days corresponding to the historical ranking information. It can be seen that, a smaller value of rᵢ^{a} indicates a higher ranking of the application a on the leaderboard on the i^{th} day.

After an application is released, any user can rate it. In fact, a user rating is one of the most important characteristics for application promotion. An application with a better rating attracts more users to purchase or download it, causing the application to rank higher on a leaderboard. Therefore, the historical ranking information may comprise historical rating information, that is, rating information made by an application user to the application in each historical time period.

Similarly, after an application is released, any user can comment it textually. In fact, a user comment is one of the most important characteristics for application promotion. An application with a more positive comment attracts more users to purchase or download it, causing the application to rank higher on a leaderboard. Therefore, the historical ranking information may comprise historical comment information, that is, comment information made by an application user to the application in each historical time period.

Similarly, after an application is released, any user can purchase, download and use the application or rate or textually comment the application. User credit of each application can be rated (for example, levels 1 to 5 are comprised, 5 indicates the highest user credit, and 1 indicates the worst user credit) by collecting and analyzing the user acts (for example, collecting statistics, by using a mobile terminal, on the number of times and a frequency that the user uses the downloaded or purchased application, and the like) in combination with other network acts of the user (such as an act of the user in a social network, an act of the user in another application store, a history of a previous ranking fraud act of the user), to be used as credibility of the user. Therefore, the historical ranking information may comprise historical user credibility information, that is, user credibility information of a certain application or all applications on an application leaderboard in each historical time period. Correspondingly, in the present application, a corresponding user implementing a user act (comprising purchasing, downloading and using an application or rating or textually commenting the application) in a leading session of the application is referred to as a “leading user” of the application, and corresponding credibility information of the leading user in the leading session is referred to as “leading user credibility”.

In the historical ranking information acquisition step, the historical ranking information may be acquired in many manners. For example, the historical ranking information may be directly acquired from an application store operator, and the historical ranking information may also be extracted from data continuously released by an application store in a long historical session.

S10: The leading session detection step: detecting the leading session of the application based on the historical ranking information.

The leading session indicates that an application ranks high on an application leaderboard, that is, a session in which user attention is high, and therefore, a ranking fraud act causing greater impacts on the application market only occurs in the leading session. Therefore, in the embodiment of the present application, for detecting ranking fraud, the leading session of the application needs to be first detected from the historical ranking information of the application.

In an exemplary embodiment of the present application, the leading session detection step may further comprise a leading event detection step: detecting a leading event of the application based on the historical ranking information.

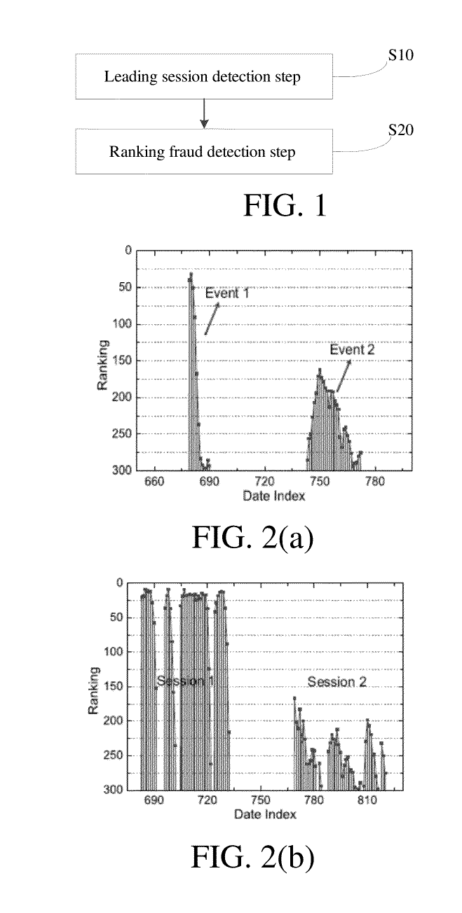

As application developers all expect that their applications rank high on a leaderboard, it is possible that the application developers use a ranking fraud means to rank their applications the top of the leaderboard. It is found through analysis that an application may not rank high on a leaderboard all the time, and a session in which a ranking is continuously high is a “leading event”. FIG. 2a illustrates an example of a leading event of an application, in the figure, the horizontal axis indicates a date index corresponding to historical ranking information, the vertical axis indicates a ranking of the application, and Event 1 and Event 2 in the figure indicate two leading events that occur in a ranking history of the application, whose contours are separately formed by connecting ranking points during the leading events.

In the embodiment of the present application, a criterion for an application to rank high on an application leaderboard is that a ranking of the application is not greater than a ranking threshold K*. As a ranking of an application among the top K* on the leaderboard is considered as a high ranking, a time period in which the ranking of the application is continuously among the top K* can be considered as a leading event, and the leading event should start when the application begins to rank the top K* on the leaderboard, and end when the application falls out of the top K* on the leaderboard.

Preferably, the method in the embodiment of the present application may further comprise a step of setting the ranking threshold K*, so as to determine the criterion for an application to rank high an application leaderboard. As the total number K of applications on the leaderboard is usually large, such as 1000, the ranking threshold K* is usually less than a value of K. According to factors such as the total number K of applications on the application leaderboard and analysis demands of those skilled in the art, the ranking threshold K* may be an integer between 1 and 500. Those skilled in the art can understand that, a smaller value of K* indicates a higher criterion for the application to be considered to rank high. In FIG. 2a, the value of K* is 300.

According to the literal expressions about a leading event, a leading event e of the application a can be expressed formulaically as follows:

A ranking threshold K* is given as a criterion for a high ranking, wherein K*∈[1, K]; the leading event e of the application a comprises a date range Tₑ=[tₛₜₐᵣₜ^{e},t_{end}^{e}] from a start date to an end date, the ranking of the corresponding application a meets rₛₜₐᵣₜ^{a}≦K*<rₛₜₐᵣₜ₋₁^{a} and r_{end}^{a}≦K*<r_{end+1}^{a}, and ∀tₖ∈(tₛₜₐᵣₜ^{e},t_{end}^{e}) meets rₖ^{a}≦K*.

It can be seen according to the foregoing expressions that, what is important for detecting a leading event is detecting a start date and an end date of a time period in which an application continuously ranks the top K*, and a session between a pair of a start date and an end date is determined as a leading event. Therefore, in the embodiment of the present application, the leading event detection step may further comprise the following steps.

A start date identification step S101: in this step, a start date of the leading event is identified from the historical ranking information. Specifically, in the start date identification step, a ranking of the application on each date point in the historical ranking information can be searched for sequentially, and when a ranking on a current date point is not greater than the ranking threshold K* and a ranking on a previous date point is greater than the ranking threshold K*, the current date point is identified as the start date of the leading event. Those skilled in the art can understand that, as the ranking history of the application may comprise a plurality of leading events, a plurality of start date points may be identified in the start date identification step.

An end date identification step S102: in the step, an end date of the leading event is identified from the historical ranking information. Specifically, in the end date identification step, a ranking of the application on each date point in the historical ranking information can be searched for sequentially, and when a ranking on a current date point is greater than the ranking threshold K* and a ranking on a previous date point is not greater than the ranking threshold K*, the previous date point is identified as the end date of the leading event. Those skilled in the art can understand that, as the ranking history of the application may comprise a plurality of leading events, a plurality of end date points may be identified in the end date identification step.

A leading event identification step S103: in the step, a time period between each start date and an end date adjacent to and after the start date is identified as a leading event, so that all leading events in the ranking history of the application are detected.

It should be noted that, as a special case, if, on the first date point of an analyzed and processed historical session, for example, on the first day in a historical record, the application ranks the top K* on the leaderboard, at this time, in the start date identification step S101, the first date point is defined as a start date. Similarly, if, on the last date point of the analyzed and processed historical session, for example, today, the application still ranks the top K* on the leaderboard, at this time, in the end date identification step S102, the last date point is defined as an end date.

Manners of detecting a leading event in the application are introduced above, and on this basis, in an exemplary embodiment of the present application, adjacent leading events can be merged to form the leading session in the leading session detection step.

It is found through further research that, adjacent leading events may occur in some applications in a session continuously and for a plurality of times, and the session is a “leading session” of the application in the present application. It can be seen that, adjacent leading events are merged to form a leading session. Specifically, that a time interval between two adjacent leading events is less than an interval threshold φ can be used as a criterion for merging two leading events in a same leading session, and the time interval between the two adjacent leading events refers to an interval between an end date of the former leading event and a start date of the latter leading event in the two adjacent leading events.

Preferably, the method in the embodiment of the present application may further comprise a step of setting the interval threshold φ, so as to determine the criterion for merging two leading events in a same leading session. According to factors such as analysis demands of those skilled in the art, a value of the interval threshold φ may be an integer in 2 to 10 times of the update cycle of the application leaderboard. Those skilled in the art can understand that, a smaller value of the interval threshold φ indicates a higher criterion for merging two leading events in a same leading session.

FIG. 2b illustrates an example of a leading session of an application, in the figure, the horizontal axis indicates a date index corresponding to historical ranking information, the vertical axis indicates a ranking of the application, Session 1 and Session 2 in the figure indicate two leading sessions that occur in a ranking history of the application, and each leading session is formed by a plurality of leading events.

According to the literal expressions about a leading session, a leading session s of the application a can be expressed formulaically as follows:

The leading session s of the application a comprises a date range Tₛ=[tₛₜₐᵣₜ^{s},t_{end}^{s}] and n adjacent leading events {e₁, . . . , eₙ}, which meets tₛₜₐᵣₜ^{s}=tₛₜₐᵣₜ^{e}^{₁},t_{end}^{s}=t_{end}^{e}^{ₙ} and does not have another leading session s* to make Tₛ⊂T_{s*}. In addition, for ∀i∈[1,n), (tₛₜₐᵣₜ^{e}^{ᵢ₊₁}−e_{end}^{e}^{ᵢ})<φ, wherein φ indicates a preset leading event interval threshold, and is a determining criterion used to determine the degree of adjacency between leading events so as to incorporate them to a same leading session.

It can be seen according to the foregoing expressions that, what is important for detecting a leading session is merging adjacent leading events in a ranking history of an application based on the interval threshold φ to form a leading session. Specifically, in the leading session detection step of the embodiment of the present application, each detected leading event is searched for sequentially from an initial date point in the historical ranking information, and when a time interval between a current leading event and a previous leading event is less than the interval threshold φ, the two leading events are merged in a same leading session, until all detected leading events have been searched for, to detect all leading sessions of the application in the ranking history.

It should be noted that, as a special case, if a leading event is not adjacent to any other leading events, the leading event may also be considered to form a leading session. In this case, in the leading session detection step, when a time interval between a leading event and a previous leading event is not less than the interval threshold φ and a time interval between the leading event and a next leading event is not less than the interval threshold φ, the leading event is detected as a leading session.

As stated above, the detected leading session indicates that the application ranks high on the application leaderboard, that is, a time period popular with users, and the detected leading session may be used as a data basis for various application services comprising ranking fraud detection. Therefore, after the leading session of the application is detected, as an exemplary embodiment of the present application, information of the detected leading session of the application may be sent to an application developer, an application store operator, or an application terminal user.

For an application developer, the application developer can analyze a development trend of a related technical field or demands of an application user according to the information of the leading session, so as to guide application development and operation; for an application store operator, the application store operator can further analyze, according to the information of the leading session, a ranking fraud act of using a fraud means to acquire a false high ranking on a leaderboard, so as to improve the operation of an application store; while for an application terminal user, according to the information of the leading session, the application terminal user can determine a possibility that ranking fraud exists in the application or select an application meeting demands of the application terminal user.

In addition, as an embodiment of detecting a leading event and a leading session of an application, the following algorithm 1 illustrates an example of detecting program code of a leading session in historical ranking information of the given application a.

Algorithm 1 Mining Leading Sessions

| Input 1: a's historical ranking records Rₐ; | |
|---|---|
| Input 2: the ranking threshold K*; the merging threshold φ; | |
| Output: the set of a's leading sessions Sₐ; | |
| Initialization: Sₐ = ; | |
| 1: | Eₐ = ; e = ; s = ; tₛₜₐᵣₜ^{e} = 0; |
| 2: | for each i ∈ [1,\|Rₐ\|] do |
| 3: | if rᵢ^{a} ≦ K* and tₛₜₐᵣₜ^{e} == 0 then |
| 4: | tₛₜₐᵣₜ = tᵢ; |
| 5: | else if rᵢ^{a} > K* and tₛₜₐᵣₜ^{e} ≠ 0 then |
| 6: | //found one event; |
| 7: | t_{end}^{e} = tᵢ₋₁; e =< tₛₜₐᵣₜ^{e},t_{end}^{e} >; |
| 8: | if \|Eₐ\| == then |
| 9: | Eₐ∪ = e; tₛₜₐᵣₜ^{s} = tₛₜₐᵣₜ^{e}; t_{end}^{s} = t_{end}^{e}; |
| 10: | else if \|Eₐ\| > 1 and (tₛₜₐᵣₜ^{e} − t_{end}^{e*}) < φ then |
| 11: | //e* is the last leading event before e in Eₐ; |
| 12: | Eₐ∪ = e; t_{end}^{s} = t_{end}^{e}; |
| 13: | else then //found one session; |
| 14: | s =< tₛₜₐᵣₜ^{s} , t_{end}^{s}, Eₐ >; |
| 15: | Sₐ∪ = s; Eₐ = ; s = is a new session; |
| 16: | go to Step 7; |
| 17: | tₛₜₐᵣₜ^{e} = 0; e = is a new leading event; |
| 18: | return Sₐ |

In the algorithm 1, each leading event e is defined as [symbol] tₛₜₐᵣₜ^{e},t_{end}^{e} [symbol] , and the leading session s is defined as [symbol] tₛₜₐᵣₜ^{s},t_{end}^{s},Eₛ [symbol] , wherein Eₛ indicates a set of leading events in the leading session s. Particularly, each leading event e of the application a is first extracted from a start date in the historical ranking information (steps 2 to 5 in the algorithm 1). For each extracted leading event e, a time interval between e and a previous leading event e* is detected to determine whether they belong to a same leading session. Specifically, if (tₛₜₐᵣₜ^{e}−e_{end}^{e*})≧φ, the leading event e is considered to belong to a new leading session (steps 7 to 13 in the algorithm 1). In this way, the algorithm 1 can identify the leading event and the leading session by scanning the historical ranking information of the application a once.

The ranking fraud detection step S20: detecting the leading session based on the at least one piece of evidence, to obtain the ranking fraud detection result.

As an exemplary embodiment of the present application, the ranking fraud detection step may further comprise an evidence verification step: verifying the leading session based on the at least one piece of evidence and obtaining a fraud parameter. In this way, after particular evidence is extracted, a fraud parameter corresponding to the evidence can be calculated, and the fraud parameter can be used as the ranking fraud detection result in the ranking fraud detection method in the embodiment. As factors that affect a particular characteristic of the application are complicated, whether ranking fraud exists in an application cannot be accurately determined by only depending on one piece of or one kind of evidence, but only a detection value (the fraud parameter) for reference is obtained; however, those skilled in the art can determine, according to the fraud parameter, a possibility that ranking fraud exists in the application.

In the embodiment of the present application, four kinds of evidence used to detect ranking fraud can be extracted separately, which are ranking-related evidence, user rating-related evidence, user comment-related evidence and leading user credibility-related evidence, separately. The four kinds of evidence and specific steps of detecting ranking fraud by using the four kinds of evidence in the embodiment of the present application are introduced below separately.

### (1) Ranking-Related Evidence

As the above introduction to the historical ranking information, the historical ranking information comprises a ranking index corresponding to a discrete date index, wherein each element in the ranking index corresponds to one discrete date point in the date index, indicating a ranking of the application in the discrete date point. Meanwhile, the leading session is a session in which ranking fraud may occur in the application. Therefore, a ranking characteristic of the historical ranking information in the leading session of the application can be analyzed, to extract some information related to the ranking, as evidence used to detect ranking fraud.

As one leading session may comprise one or more leading events, in order to extract evidence used to detect ranking fraud in the leading session, as an exemplary embodiment of the present application, the ranking fraud detection step may further comprise a leading event analysis step, to analyze some basic ranking characteristics of each leading event in the leading session, for example, identify a raising phase, a maintaining phase, and a recession phase of the leading event.

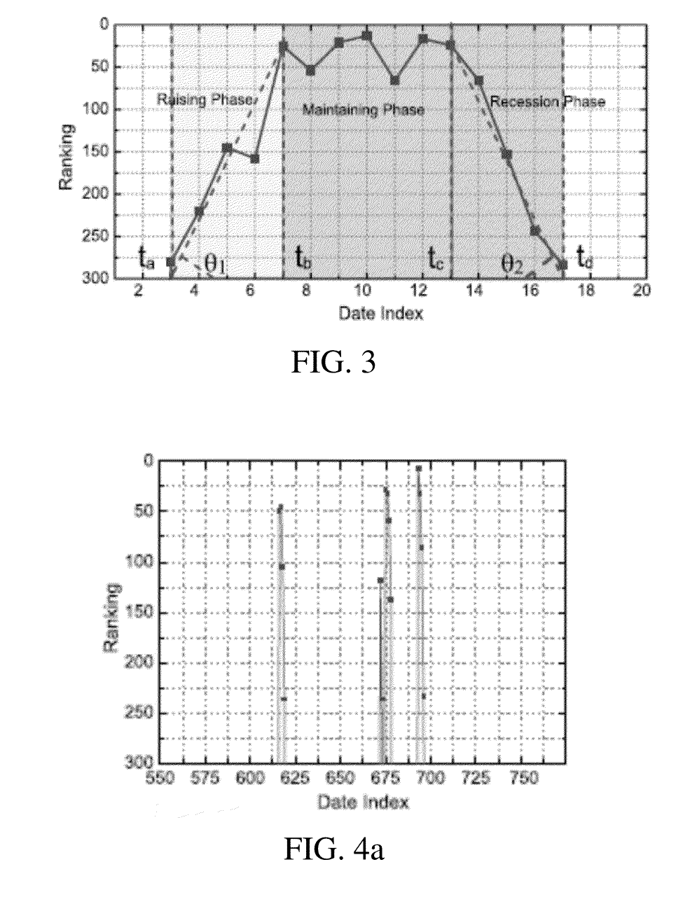

Specifically, it can be known by analyzing the historical ranking information of the application that, ranking acts of the application in the leading event generally meet a particular ranking characteristic, that is, all comprise three different ranking phases: a raising phase, a maintaining phase, and a recession phase. In each leading event, the ranking of the application first moves up to a peak range of the leaderboard (that is, the raising phase), then is maintained for a session in the peak range (that is, the maintaining phase), and finally, the ranking falls until the leading event ends (that is, the recession phase). FIG. 3 illustrates an example of different ranking phases in a leading event; in the figure, the horizontal axis indicates a date index corresponding to historical ranking information, and the vertical axis indicates a ranking of an application.

Based on the foregoing literal expressions, the three phases of the leading event are expressed formulaically as follows:

For the given application a, in the date range [tₛₜₐᵣₜ^{e},t_{end}^{e}] leading event e, a position of the highest ranking of the application a is rₚₑₐₖ^{a}, which is in a range of ΔR. The raising phase of the leading event e refers to a date range [tₐ^{e},t_{b}^{e}], wherein tₐ^{e}=tₛₜₐᵣₜ^{e}, r_{b}^{a}∈ΔR, and ∀tᵢ∈[tₐ^{e},t_{b}^{e}) meets rᵢ^{a}∉ΔR. The maintaining phase of the leading event e refers to a date range [t_{b}^{e},t_{c}^{e}], where r_{c}^{a}531 ΔR and Δtᵢ∈(t_{c}^{e},t_{end}^{e}] meets rᵢ^{a}∉ΔR. The recession phase of the leading event refers to a date range [t_{c}^{e},t_{d}^{e}], wherein t_{d}^{e}=t_{end}^{e}.

It should be noted that, in the foregoing descriptions, ΔR indicates a ranking range that determines a start date and an end date of the maintaining phase, and t_{b}^{e} and t_{c}^{e} respectively indicate the first date and the last date of the ranking of the application a in the ranking range ΔR. Those skilled in the art can set the range of ΔR according to analysis demands, so as to divide phases of the leading event, for example, the range of ΔR in FIG. 3 is that the application ranks the top 70 on the leaderboard. In an exemplary embodiment of the present application, a manner of identifying the three phases in the leading event analysis step is: determining the first date and the last date of the ranking of the application in the peak range ΔR in the leading event, identifying a time period between the first date and the last date as the maintaining phase, identifying a time period before the maintaining phase in the leading event as the raising phase, and identifying a time period after the maintaining phase in the leading event as the recession phase.

For an application, even if ranking fraud exists, the application cannot be maintained in a same peak position all the time, for example, the application always ranks the first on a leaderboard, but is maintained in a peak range, for example, the top 25 on the leaderboard or the like. If ranking fraud exists in a leading session s of the application a, ranking acts in the three phases of the leading event may be different from leading sessions of normal applications. In fact, each application in which ranking fraud exists always has a desired ranking goal, for example, the application is maintained in the top 25 on a leaderboard for one week or the like, and meanwhile, persons hired to implement a ranking fraud act are paid according to the ranking goal (for example, they are paid $1000 a day in the time when it is maintained in the top 25 or the like). Therefore, for an application developer or persons hired, the sooner the ranking goal is reached, the faster they can get profits. In addition, after the ranking goal is reached and maintained for a desired session, the ranking fraud act is stopped, and the ranking of the application may drop abruptly. It can be seen that, a leading event in which ranking fraud occurs may show a very short raising phase and a very short recession phase. Meanwhile, as ranking an application high on a leaderboard through ranking fraud is costly, the application in which ranking fraud exists usually only has a very short maintaining phase in each leading event to cause the application to rank high on the leaderboard.

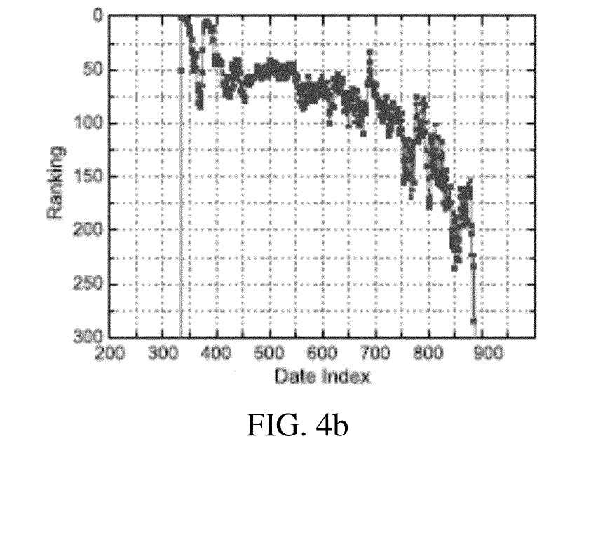

FIG. 4a illustrates a ranking record of an application suspected of having ranking fraud. In the figure, it can be seen that the application has a plurality of pulse leading events.

On the contrary, for a normal application, ranking acts in leading events thereof are entirely different. For example, FIG. 4b illustrates a ranking record of a normal application very popular with users, which comprises a leading event having a very long date range (longer than 1 year), especially in a recession phase. In fact, once a normal application climbs to a high ranking on a leaderboard, it usually has a large group of loyal fans and possibly attracts more and more users to download it, and therefore the application will rank high on the leaderboard for a long time. Based on the foregoing analysis, in the present application, some ranking-related identification marks may be extracted from a leading session of the application to construct evidence (ranking-related evidence), and the evidence is used to detect existence of ranking fraud.

It can be known according to the foregoing analysis on the three phases of a leading event that, a leading event in which ranking fraud occurs will show a very short raising phase and a very short recession phase, and therefore, in an exemplary embodiment, ranking-related evidence may be formed based on some ranking characteristics reflected by the raising phase and/or the recession phase in the leading event in a leading session, and an evidence value is calculated based on the formed evidence, as a fraud parameter used to determine ranking fraud.

For example, as the raising phases and the recession phases of the leading events in the leading session have been identified in the leading event analysis step, an average value of date ranges of raising phases of all leading events in the leading session can be calculated (for example, if the leading session comprises 3 leading events, the average value is the sum of date ranges of 3 raising phases of the 3 leading events divided by 3), or an average value of date ranges of recession phases of all leading events, or an average value of the sum of date ranges of raising phases and date ranges of recession phases of all leading events, to be used as the fraud parameter.

For another example, an average angle value of acute angles formed by intersection of curves of raising phases of all leading events in the leading session and a date axis, or an average angle value of acute angles formed by intersection of curves of recession phases of all leading events and a date axis, or an average value of the angle sum of acute angles formed by intersection of curves of raising phases as well as curves of recession phases of all leading events and a date axis can be calculated as the fraud parameter. As shown in FIG. 3, two acute angle parameters θ₁ and θ₂ respectively illustrate an acute angle formed by intersection of a curve (a curve formed by connecting adjacent ranking value points in the raising phase) of the raising phase and a date axis, and an acute angle formed by intersection of a curve (a curve formed by connecting adjacent ranking value points in the recession phase) of the recession phase and the date axis in the leading event e of the application a. According to the formulistic description about the three phases in the leading event in the leading event analysis step, those skilled in the art can calculate the parameters θ₁ and θ₂ through the following formulas:

$${θ}_{1}^{e} = arctan ( \frac{{K}^{*} - {r}_{b}^{a}}{{t}_{b}^{e} - {t}_{a}^{e}} ) , {θ}_{2}^{e} = arctan ( \frac{{K}^{*} - {r}_{c}^{a}}{{t}_{d}^{e} - {t}_{c}^{e}} ) \qquad ( 1 )$$

wherein K* indicates a ranking threshold of a high ranking.

It can be seen that, a larger value of θ₁ indicates that the application a climbs to a high ranking in a shorter time; a larger value of θ₂ indicates that the application a drops abruptly to the bottom of the ranking from a high ranking in a much shorter time. Therefore, for a leading session, if it comprises more leading events having a larger value of θ₁ or a larger value of θ₂, it indicates a larger possibility that ranking fraud exists in the leading session. For example, when the average value of the angle sum of the acute angles formed by intersection of the curves of the raising phases as well as the curves of the recession phases of all the leading events and the date axis is used as the fraud parameter, the fraud parameter θ̅ₛ̅ can be further described herein as follows:

$$\overline{{θ}_{s}} = \frac{1}{\vert {E}_{s} \vert} {\sum }_{e ∈ s}^{ } ( {θ}_{1}^{e} + {θ}_{2}^{e} ) \qquad ( 2 )$$

wherein |Eₛ| indicates the total number of leading events comprised in the leading session s. It can be seen that, compared with leading sessions of other applications on a leaderboard, if a leading session s of an application comprises an evidently larger value of θ̅ₛ̅, there is a larger possibility that ranking fraud exists in the application.

It can be known according to the foregoing analysis on the three phases of a leading event that, an application in which ranking fraud exists usually only has a short maintaining phase in each leading event to cause the application to rank high on a leaderboard; therefore, in an exemplary embodiment of the present application, ranking-related evidence may be formed based on some ranking characteristics reflected by the maintaining phase in the leading event in a leading session, and an evidence value is calculated based on the formed evidence, as a fraud parameter used to determine ranking fraud.

For example, as the maintaining phases of the leading events in the leading session have been identified in the leading event analysis step, an average value of date ranges of maintaining phases of all leading events in the leading session can be calculated as the fraud parameter.

For another example, the fraud parameter can be calculated based on an average ranking of the application in the maintaining phases of all the leading events in the leading session and date ranges of the leading events. Specifically, as discussed above, an application in which ranking fraud exists usually has a short maintaining phase in a leading event; therefore, if Δtₘ^{e}=(t_{c}^{e}−t_{b}^{e}+1) is used to indicate a date range of the maintaining phase of the leading event e, and an average ranking of the application a in the maintaining phase is indicated as r̅ₘ̅^̅{̅e̅}̅, for example, a fraud parameter Xₛ of a leading session can be defined as follows:

$${X}_{s} = \frac{1}{\vert {E}_{s} \vert} {\sum }_{e ∈ s}^{ } \frac{{K}^{*} - {\overline{r}}_{m}^{e}}{Δ {t}_{m}^{e}} \qquad ( 3 )$$

wherein K* indicates a ranking threshold of a high ranking. It can be seen that, compared with leading sessions of other applications on a leaderboard, if a leading session s of an application comprises an evidently larger value of Xₛ, there is a larger possibility that ranking fraud exists in the application.

In addition, those skilled in the art can understand that, the number |Eₛ| of leading events comprised in the leading session s of the application is also an important mark for existence of ranking fraud. For a normal application, a recession phase indicates reduction of popularity, and therefore, it is unlikely that another leading event occurs in a short term after a leading event ends, unless an updated version is introduced for the application or another commercially promotional means is used. Therefore, compared with leading sessions of other applications on a leaderboard, if a leading session of an application comprises much more leading events than the leading sessions of the other applications on the leaderboard, there is a larger possibility that ranking fraud exists in the application.

According to the foregoing analysis on the number of leading events in the leading session, in an exemplary embodiment, ranking-related evidence may be formed based on the number of leading events in the leading session, and the number |Eₛ| of leading events in the leading session is determined based on the formed evidence, as a fraud parameter used to determine ranking fraud.

### (2) User Rating-Related Evidence

Ranking-related evidence is very important for detecting ranking fraud, however, sometimes, use of the ranking-related evidence is not always effective. For example, some applications are developed by famous developers, and affected by credit and public praise of the developers, raising phases of leading events of the applications have a large value of θ₁. In addition, affected by some legal market services such as “limited time discount”, some ranking-related evidence may appear. In order to solve these problems, in the embodiment of the present application, how to extract other characteristics from the historical ranking information to be used as evidence of detecting ranking fraud is also studied.

As the above introduction to the historical ranking information, the historical ranking information comprises historical rating information, that is, a user rating made by an application user to the application in each historical time period. Meanwhile, a leading session is a session in which ranking fraud may occur in the application. Therefore, a rating characteristic of the historical ranking information in the leading session of the application can be analyzed, to extract some information related to a user rating, as evidence used to detect ranking fraud.

Specifically, after an application is released, any download user can rate it, for example, the application is scored 1 to 5 points, usually, 5 points indicates that the user is very satisfied with the application (the highest rating), while 1 point indicates that the user is very dissatisfied (the lowest rating). In fact, a user rating is one of the most important characteristics for application promotion. An application with a higher rating attracts more users to purchase or download it, causing the application to rank higher on a leaderboard. Therefore, a false rating is also an important manifestation in ranking fraud. If ranking fraud exists in the leading session s of the application, a rating in a time period of the leading session s will have an abnormal characteristic different from a rating in other historical phases, and the characteristic can be used to construct user rating-related evidence used to detect ranking fraud.

For a normal application, an average user rating in a particular leading session should be consistent with an average rating in all historical rating records of the normal application. On the contrary, for an application in which ranking fraud exists, the application will have a surprisingly high rating in a leading session of the application compared with a historical rating of the application. As an exemplary embodiment of the present application, user rating-related evidence may be formed based on an average user rating R̅ₛ and a historical average rating R̅ₐ in a leading session, and an evidence value is calculated based on the formed evidence, as a fraud parameter used to determine ranking fraud.

For example, intuitively, a difference between an average value R̅ₛ of all user ratings and a historical average rating R̅ₐ in the leading session or a ratio between an average value R̅ₛ of all user ratings and a historical average rating R̅ₐ can be calculated as the fraud parameter.

For another example, a ratio of a difference between an average value R̅ₛ of all user ratings and a historical average rating R̅ₐ in the leading session to the historical average rating R̅ₐ can be calculated as the fraud parameter. The fraud parameter ΔRₛ is formulaically described as follows:

$$Δ {R}_{s} = \frac{{\overline{R}}_{s} - {\overline{R}}_{a}}{{\overline{R}}_{a}} , ( s ∈ a ) \qquad ( 1 )$$

wherein R̅ₛ indicates an average user rating value in the leading session, and R̅ₐ indicates a historical rating average value of the application a. Therefore, compared with leading sessions of other applications on a leaderboard, if a leading session s of an application comprises an evidently larger value of ΔRₛ, there is a larger possibility that ranking fraud exists in the application.

In rating information of the application, each rating can be classified into a discrete rating hierarchy |L|, for example, levels 1 to 5 are comprised, which indicate the degree of preference of users for the application. For a normal application a, distribution p(lᵢ|R_{s,a}) of a rating level lᵢ in a leading session s should be consistent with distribution p(lᵢ|Rₐ) in its historical rating record. As an exemplary embodiment of the present application, user rating-related evidence may be formed based on distribution of a rating levels of the application in the leading session and distribution of a rating level in historical rating information, and an evidence value is calculated based on the formed evidence, as a fraud parameter used to determine ranking fraud.

For example, a difference between the distribution of the rating level of the application in the leading session and the distribution of the rating level in the historical rating information can be calculated as the fraud parameter. Specifically, a value of p(lᵢ|R_{s,a}) can be first calculated through

$$p ( {l}_{i} \vert {R}_{s , a} ) = ( \frac{{N}_{{l}_{i}}^{s}}{{N}_{( . )}^{s}} ) ,$$

wherein Nₗ_{ᵢ}^{s} indicates the number of user ratings whose rating level is lᵢ in the leading session, and N_{(.)}^{s} indicates the total number of ratings in the leading session s; meanwhile, p(lᵢ|Rₐ) can be calculated in a similar manner; then the difference between the distribution of the rating level of the application in the leading session and the distribution of the rating level in the historical rating information is calculated. As an embodiment, the difference can be estimated by using a cosine distance D(s) between p(lᵢ|R_{s,a}) and p(lᵢ|Rₐ). The fraud parameter D(s) is formulaically described as follows:

$$D ( s ) = \frac{{\sum }_{i = 1}^{\vert L \vert} p ( {l}_{i} \vert {R}_{s , a} ) \times p ( {l}_{i} \vert {R}_{a} )}{\sqrt{{\sum }_{i = 1}^{\vert L \vert} {p ( {l}_{i} \vert {R}_{s , a} )}^{2}} \times \sqrt{{\sum }_{i = 1}^{\vert L \vert} {p ( {l}_{i} \vert {R}_{a} )}^{2}}} \qquad ( 2 )$$

It can be seen that, compared with leading sessions of other applications on a leaderboard, if a leading session s of an application comprises an evidently larger value of D(s) , there is a larger possibility that ranking fraud exists in the application.

### (3) User Comment-Related Evidence

As the above introduction to the historical ranking information, the historical ranking information comprises historical comment information, that is, a user comment made by an application user to the application in each historical time period. Meanwhile, a leading session is a session in which ranking fraud may occur in an application. Therefore, a user comment characteristic of the historical ranking information in the leading session of the application can be analyzed, to extract some information related to a user comment, as evidence used to detect ranking fraud.

Specifically, after an application is released, most application websites or application stores allow users to write user comments in a text format to the application. The user comments can reflect personal viewpoints or use experience of the users to a particular application. In fact, a user comment is one of the most import characteristics for application promotion, and a fake user comment is one of the most important aspects of ranking fraud. Before downloading or purchasing a new application, a user may usually browse a user comment in historical comment information first to help the user to make a decision, and an application with more positive comments attracts more users to purchase or download it, causing the application to rank higher on a leaderboard. Therefore, a ranking counterfeiter may often release a false user comment for a particular application to excite purchases or downloads of the application, so as to quickly improve a ranking of the application on the leaderboard. If ranking fraud occurs in a leading session s of the application, a user comment in a time period of the leading session s will have an abnormal characteristic different from user comments in other historical phases, and the characteristic can be used to construct user comment-related evidence used to detect ranking fraud.

In fact, as the manpower cost is excessively high, most false user comments are implemented by a preset machine. Therefore, a user comment counterfeiter usually frequently releases lots of identical or similar user comments to improve the ranking of the application. On the contrary, as different users have different personal viewpoints and use experience, a normal application may usually have diversified user comments. As an exemplary embodiment of the present application, user comment-related evidence may be formed based on a similarity between user comments in the leading session, and an evidence value is calculated based on the formed evidence, as a fraud parameter used to determine ranking fraud.

For example, an average similarity Sim(s) between user comments in the leading session s can be calculated as the fraud parameter. Specifically, the fraud parameter Sim(s) can be calculated by using the following steps.

First, standardized processing is performed on each user comment c in the leading session s. For example, for a Chinese user comment, function words such as “ [symbol] ” and “ [symbol] ” can be deleted, and for an English user comment, words such as of and the can be deleted, and variants of verbs and adjectives are removed and the like (such as plays is changed into play and better is changed into good).

Then, a standardized vocabulary vector \vec{ω_{c}}=dim[n] is constructed for each user comment c, wherein n indicates the total number of all different standardized vocabularies in all user comments in the leading session s. Specifically, there may be

$$dim [ i ] = \frac{{freq}_{i , c}}{{\sum }_{i} {freq}_{i , c}} ( 1 \leq i \leq n ) ,$$

wherein freq_{i,c} indicates a frequency that the i^{th} vocabulary occurs in the user comment c.

Finally, a similarity between a user comment cᵢ and a user comment cⱼ can be calculated by using a cosine similarity Cos(\vec{ω_{c}_{ᵢ}},\vec{ω_{c}_{ⱼ}}). Therefore, the fraud parameter Sim(s) can be calculated by using, for example, the following formula:

$$Sim ( s ) = \frac{2 \times {\sum }_{1 \leq i \leq j \leq {N}_{s}} Cos ( \vec{{ω}_{{c}_{i}}} , \vec{{ω}_{{c}_{j}}} ) }{{N}_{s} \times ( {N}_{s} - 1 )} \qquad ( 3 )$$

wherein Nₛ indicates the total number of user comments in the leading session s.

It can be seen that, a larger value of Sim(s) indicates that more identical or similar user comments are comprised in the leading session s. Therefore, compared with leading sessions of other applications on a leaderboard, if a leading session s of an application comprises an evidently larger value of Sim(s), there is a larger possibility that ranking fraud exists in the application.

It is found through the analysis on the user comment of the application that, each user comment c may be related to a particular latent theme z. For example, some user comments are related to a latent theme “worth downloading”, and some user comments are related to a latent theme “very boring”. Meanwhile, as different users have different personal preference for applications, each application a should have different theme distribution in its user comment historical record. For a normal application a, theme distribution p(z|s) of a user comment in a leading session s should be consistent with theme distribution p(z|a) of a user comment of the application a in the entire historical record. On the contrary, if an application has a false user comment in its leading session s, the foregoing two kinds of theme distribution may vary significantly, for example, more positive user comments may appear in the leading session, such as “worth downloading” and “being popular”. As an exemplary embodiment of the present application, user comment-related evidence may be formed based on theme distribution of a user comment of the application in the leading session and theme distribution of a user comment in historical comment information, and an evidence value is calculated based on the formed evidence, as a fraud parameter used to determine ranking fraud.

For example, a difference between the theme distribution of the user comment of the application in the leading session and the theme distribution of the user comment in the historical comment information can be calculated as the fraud parameter.

In the prior art, there are various theme modeling technologies for extracting a latent theme. In the embodiment of the present application, a Latent Dirichlet Allocation Model widely used in the prior art can be used to extract all latent themes in the user comments (D. M. Blei, A. Y. Ng, and M. I. Jordan. Latent dirichlet allocation. Journal of Machine Learning Research, Pages 993-1022, 2003). Afterwards, the difference between the theme distribution of the user comment of the application in the leading session and the theme distribution of the user comment in the historical comment information can be calculated based on all latent themes in the extracted user comments.

Specifically, a value of p(zᵢ|s) can be first calculated by using

$$p ( {z}_{i} \vert s ) = ( \frac{{N}_{{z}_{i}}^{s}}{{N}_{( . )}^{s}} ) ,$$

wherein N_{z}_{ᵢ}^{s} indicates the number of user comments whose user comment theme is zᵢ in the leading session s, and N_{(.)}^{s} indicates the total number of user comments in the leading session s; meanwhile, p(zᵢ|a) can be calculated in a similar manner; then the difference between the theme distribution of the user comment of the application in the leading session and the theme distribution of the user comment in the historical comment information is calculated. As an embodiment, the difference can be estimated by using a cosine distance D(s) between p(zᵢ|s) and p(zᵢ|a). The fraud parameter D(s) is formulaically described as follows:

$$D ( s ) = \frac{{\sum }_{i = 1}^{M} p ( {z}_{i} \vert s ) \times p ( {z}_{i} \vert a )}{\sqrt{{\sum }_{i = 1}^{M} {p ( {z}_{i} \vert s )}^{2}} \times \sqrt{{\sum }_{i = 1}^{M} {p ( {z}_{i} \vert a )}^{2}}} \qquad ( 4 )$$

wherein M indicates the total number of themes of the extracted user comments. It can be seen that, compared with leading sessions of other applications on a leaderboard, if a leading session s of an application comprises an evidently larger value of D(s), there is a larger possibility that ranking fraud exists in the application.

### (4) Leading User Credibility-Related Evidence

As the above introduction to the historical ranking information, the historical ranking information comprises historical user credibility information, that is, user credibility information of a certain application or all applications on an application leaderboard in each historical time period. Meanwhile, a leading session is a session in which ranking fraud may occur in an application. Therefore, a user credit characteristic of the historical ranking information in the leading session of the application can be analyzed, to extract some information related to leading user credibility, as evidence used to detect ranking fraud.

Specifically, user credibility of an application can be classified into a discrete credibility hierarchy, for example, levels 1 to 5 are comprised, 5 indicates the highest user credit, while 1 indicates the worst user credit. If ranking fraud occurs in the leading session s of the application, some users with worse user credibility definitely participate in a fraud act such as false download, false rating or commenting; therefore, user credibility in a time period of the leading session s will have an abnormal characteristic different from user credibility in other historical phases, and the characteristic can be used to construct leading user credibility-related evidence used to detect ranking fraud.

For a normal application, average credibility of leading users in a particular leading session should be consistent with average credibility of all historical users of the application. On the contrary, for an application in which ranking fraud exists, average credibility of leading users in a leading session of the application may decrease significantly compared with average credibility of all historical users of the application. As an exemplary embodiment of the present application, leading user credibility-related evidence may be formed based on leading user average credibility Q̅ₛ of the application and historical user average credibility Q̅ₐ of the application, and an evidence value is calculated based on the formed evidence, as a fraud parameter used to determine ranking fraud.

For example, intuitively, a difference between the historical user average credibility Q̅ₐ of the application and the leading user average credibility Q̅ₛ of the application or a ratio between the historical user average credibility Q̅ₐ of the application and the leading user average credibility Q̅ₛ of the application can be calculated as the fraud parameter.

Therefore, compared with leading sessions of other applications on a leaderboard, if a leading session s of an application comprises an evidently larger difference or ratio, there is a larger possibility that ranking fraud exists in the application.

For a normal application, average credibility of leading users in a particular leading session should be consistent with historical user average credibility of all applications on an application leaderboard. On the contrary, for an application in which ranking fraud exists, average credibility of leading users in a leading session of the application may decrease significantly compared with historical user average credibility of all applications on an application leaderboard. As an exemplary embodiment of the present application, leading user credibility-related evidence may be formed based on leading user average credibility Q̅ₛ of the application and historical user average credibility Q̅ of all applications on an application leaderboard, and an evidence value is calculated based on the formed evidence, as a fraud parameter used to determine ranking fraud.

For example, intuitively, a difference between the historical user average credibility Q̅ of all the applications on the application leaderboard and the leading user average credibility Q̅ₛ of the application or a ratio between the historical user average credibility Q̅ of all the applications on the application leaderboard and the leading user average credibility Q̅ₛ of the application can be calculated as the fraud parameter.

Therefore, compared with leading sessions of other applications on a leaderboard, if a leading session s of an application comprises an evidently larger difference or ratio, there is a larger possibility that ranking fraud exists in the application.

In user credibility information of the application, credit of each user can be classified into a discrete user credit hierarchy |L|, for example, levels 1 to 5 are comprised, which indicate a level of user credit. For a normal application a, distribution p(lᵢ|Q_{s,a}) of leading user credibility level lᵢ in a leading session s should be consistent with distribution p(lᵢ|Qₐ) of a historical user credibility level. As an exemplary embodiment of the present application, leading user credibility-related evidence may be formed based on distribution of leading user credibility of the application and distribution of historical user credibility of the application, and an evidence value is calculated based on the formed evidence, as a fraud parameter used to determine ranking fraud.

For example, a difference between the distribution of the historical user credibility of the application and the distribution of the leading user credibility of the application can be calculated as the fraud parameter. Specifically, a value of p(lᵢ|Q_{s,a}) can be first calculated by using

$$p ( {l}_{i} \vert {Q}_{s , a} ) = ( \frac{{N}_{{l}_{i}}^{s}}{{N}_{( . )}^{s}} ) ,$$

wherein Nₗ_{ᵢ}^{s} indicates the number of leading users whose user credibility level lᵢ is in the leading session, and N_{(.)}^{s} indicates the total number of leading users in the leading session s; meanwhile, p(lᵢ|Qₐ) can be calculated in a similar manner; then the difference between the distribution of the historical user credibility of the application and the distribution of the leading user credibility of the application is calculated. As an embodiment, the difference can be estimated by using a cosine distance D(s) between p(lᵢ|Q_{s,a}) and p(lᵢ|Qₐ). The fraud parameter D(s) is formulaically described as follows:

$$D ( s ) = \frac{{\sum }_{i = 1}^{\vert L \vert} p ( {l}_{i} \vert {Q}_{s , a} ) \times p ( {l}_{i} \vert {Q}_{a} )}{\sqrt{{\sum }_{i = 1}^{\vert L \vert} {p ( {l}_{i} \vert {Q}_{s , a} )}^{2}} \times \sqrt{{\sum }_{i = 1}^{\vert L \vert} {p ( {l}_{i} \vert {Q}_{a} )}^{2}}} \qquad ( 5 )$$

It can be seen that, compared with leading sessions of other applications on a leaderboard, if a leading session s of an application comprises an evidently larger value of D(s), there is a larger possibility that ranking fraud exists in the application.

Meanwhile, for a normal application a, distribution p(lᵢ|Q_{s,a1}) of leading user credibility level lᵢ in a leading session s should be consistent with distribution p(lᵢ|Q) of historical user credibility levels of all applications on an application leaderboard. As an exemplary embodiment of the present application, leading user credibility-related evidence may be formed based on distribution of leading user credibility of the application and distribution of historical user credibility of all applications on an application leaderboard, and an evidence value is calculated based on the formed evidence, as a fraud parameter used to determine ranking fraud.

For example, a difference between the distribution of the historical user credibility of all the applications on the application leaderboard and the distribution of the leading user credibility of the application can be calculated as the fraud parameter. Specifically, a value of p(lᵢ|Q_{s,a}) can be first calculated by using

$$p ( {l}_{i} \vert {Q}_{s , a} ) = ( \frac{{N}_{{l}_{i}}^{s}}{{N}_{( . )}^{s}} ) ,$$

wherein Nₗ_{ᵢ}^{s} indicates the number of leading users whose user credibility level is lᵢ in the leading session, and N_{(.)}^{s} indicates the total number of leading users in the leading session s; meanwhile, p(lᵢ|Q) can be calculated in a similar manner; then the difference between the distribution of the leading user credibility of the application and the distribution of the historical user credibility of all the applications on the application leaderboard is calculated. As an embodiment, the difference can be estimated by using a cosine distance D(s) between p(lᵢ|Q_{s,a}) and p(lᵢ|Q). The fraud parameter D(s) is formulaically described as follows:

$$D ( s ) = \frac{{\sum }_{i = 1}^{\vert L \vert} p ( {l}_{i} \vert {Q}_{s , a} ) \times p ( {l}_{i} \vert Q )}{\sqrt{{\sum }_{i = 1}^{\vert L \vert} {p ( {l}_{i} \vert {Q}_{s , a} )}^{2}} \times \sqrt{{\sum }_{i = 1}^{\vert L \vert} {p ( {l}_{i} \vert Q )}^{2}}} \qquad ( 6 )$$

It can be seen that, compared with leading sessions of other applications on a leaderboard, if a leading session s of an application comprises an evidently larger value of D(s), there is a larger possibility that ranking fraud exists in the application.

The above introduces many kinds of evidence and various types of evidence in each kind, in addition to individually using one of them to detect ranking fraud in the foregoing exemplary embodiments, in an exemplary embodiment of the evidence verification step, a plurality of pieces of the foregoing evidence can be considered comprehensively, and corresponding fraud parameters obtained through verification based on the evidence are weighted, so as to obtain an ultimate fraud parameter. Considering that the plurality of pieces of foregoing evidence may have different dimensions, those skilled in the art can determine weighted values of the fraud parameters according to the degree of emphasis on the evidence in actual analysis demands and based on well-known normalization methods and weight determining methods in the prior art, which is not repeated herein.

The above introduces the evidence verification step in the ranking fraud detection step, which can verify the leading session based on the at least one piece of evidence and obtain a fraud parameter, and the fraud parameter can be used as the ranking fraud detection result of the ranking fraud detection method. However, in order to make those skilled in the art detect ranking fraud more conveniently, in an exemplary embodiment, the ranking fraud detection step may further comprise a fraud parameter determining step: comparing the fraud parameter obtained through calculation with a threshold according to the evidence, so as to intuitively determine whether ranking fraud exists in the application.

Those skilled in the art can understand that, based on many kinds of evidence and various types of evidence in each kind introduced above, those skilled in the art can set corresponding thresholds separately according to different natures of the evidence and detection demands, determine, according to the set thresholds, whether ranking fraud exists in the application, and use a final result of the determining, as the ranking fraud detection result of the ranking fraud detection method in the embodiment of the present application. For example, for a plurality of pieces of ranking-related evidence introduced above, if the fraud parameter is an average value of date ranges of raising phases and/or recession phases of leading events or an average value of date ranges of maintaining phases, when the calculated fraud parameter is less than a set threshold, it is determined that ranking fraud exists in the application; if the fraud parameter is another introduced situation, when the fraud parameter calculated exceeds the set threshold, it is determined that ranking fraud exists in the application. For another example, for a plurality of pieces of user rating-related evidence introduced above, when the calculated fraud parameter exceeds the set threshold, it is determined that ranking fraud exists in the application. For another example, for a plurality of pieces of user comment-related evidence introduced above, when the calculated fraud parameter exceeds the set threshold, it is determined that ranking fraud exists in the application. For another example, for a plurality of pieces of leading user credibility-related evidence introduced above, when the calculated fraud parameter exceeds the set threshold, it is determined that ranking fraud exists in the application.

After the ranking fraud detection result is obtained in the ranking fraud detection step, in an exemplary embodiment of the present application, the obtained ranking fraud detection result may also be sent to an application store operator or an application terminal user. For the application store operator, the application store operator can improve operation of an application store according to the ranking fraud detection result; while for the application terminal user, the application terminal user can select, according to the ranking fraud detection result, an application that meets demands of the application terminal user.

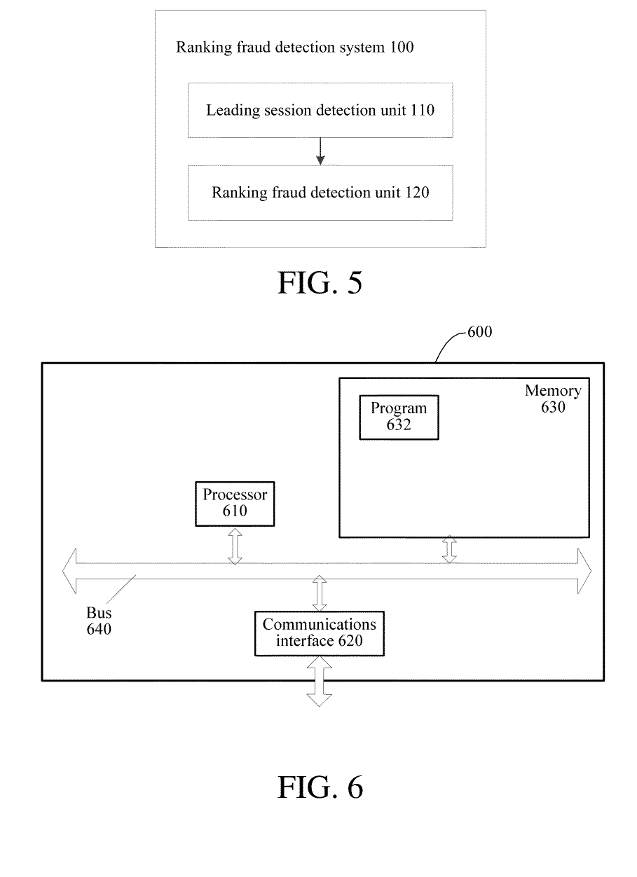

As shown in FIG. 5, in an embodiment of the present application, a ranking fraud detection system 100 for an application is further provided, wherein the system 100 comprises: a leading session detection unit 110, configured to detect a leading session of the application based on historical ranking information; and a ranking fraud detection unit 120, configured to detect the leading session based on at least one piece of evidence, to obtain a ranking fraud detection result.

Functions of the units of the detection system are described below with reference to the accompanying drawings.

As the historical ranking information is a data basis for detecting application ranking fraud in the present application, as an exemplary embodiment of the present application, the ranking fraud detection system 100 may further comprise a historical ranking information acquisition unit, configured to acquire the historical ranking information of the application on an application leaderboard.

The historical ranking information acquisition unit can acquire the historical ranking information in many manners, for example, may directly acquire the historical ranking information from an application store operator, or extract the historical ranking information from data continuously released by an application store in a long historical session, and the like.

The leading session detection unit 110 is configured to detect the leading session of the application based on the historical ranking information.

In an exemplary embodiment of the present application, the leading session detection unit 110 may further comprise a leading event detection module, configured to detect the leading event of the application based on the historical ranking information.

Preferably, the system in the embodiment of the present application may further comprise a ranking threshold setting unit, configured to set a value of a ranking threshold K*, so as to determine a criterion for an application to rank high on an application leaderboard. The value of the ranking threshold K* may be an integer between 1 and 500.

In an embodiment of the present application, the leading event detection module further comprises:

a start date identification module 111, configured to identify a start date of the leading event from the historical ranking information, wherein, specifically, the start date identification module can sequentially search for a ranking of the application on each date point in the historical ranking information, and when a ranking on a current date point is not greater than the ranking threshold K* and a ranking on a previous date point is greater than the ranking threshold K*, identify the current date point as the start date of the leading event;
an end date identification module 112, configured to identify an end date of the leading event from the historical ranking information, wherein, specifically, the end date identification module can sequentially search for a ranking of the application on each date point in the historical ranking information, and when a ranking on a current date point is greater than the ranking threshold K* and a ranking on a previous date point is not greater than the ranking threshold K*, identify the previous date point as the end date of the leading event; and
a leading event identification module 113, configured to identify a time period between each start date and an end date adjacent to and after the start date as a leading event, so that all leading events in a ranking history of the application are detected.

It should be noted that, as a special case, if, on the first date point of an analyzed and processed historical session, for example, on the first day in a historical record, the application ranks the top K* on the leaderboard, at this time, the start date identification module 111 defines the first date point as a start date. Similarly, if, on the last date point of the analyzed and processed historical session, for example, today, the application still ranks the top K* on the leaderboard, at this time, the end date identification module 112 defines the last date point as an end date.

In an exemplary embodiment of the present application, the leading session detection unit 110 is configured to merge adjacent leading events to form the leading session of the application.

Preferably, the ranking fraud detection system 100 in the embodiment of the present application may further comprise an interval threshold setting unit, configured to set a value of an interval threshold φ, so as to determine a criterion for merging two leading events in a same leading session. The value of the interval threshold φ may be an integer in 2 to 10 times of an update cycle of the application leaderboard.

In an embodiment of the present application, the leading session detection unit 110 sequentially searches for each detected leading event from an initial date point in the historical ranking information, and when a time interval between a current leading event and a previous leading event is less than the interval threshold φ, the two leading events are merged in a same leading session, until all detected leading events have been searched for, to detect all leading sessions of the application in the ranking history.

It should be noted that, as a special case, if a leading event is not adjacent to any other leading events, the leading event may also be considered to form a leading session. In this case, the leading session detection unit 110 is configured to: when a time interval between a leading event and a previous leading event is not less than the interval threshold φ and a time interval between the leading event and a next leading event is not less than the interval threshold φ, detect the leading event as a leading session.

As an exemplary embodiment of the present application, the ranking fraud detection system 100 may further comprise a leading session sending unit, configured to send information of the detected leading session of the application to an application developer, an application store operator, or an application user.

The ranking fraud detection unit 120 is configured to detect the leading session based on the at least one piece of evidence, to obtain the ranking fraud detection result.

As an exemplary embodiment of the present application, the ranking fraud detection unit 120 may further comprise an evidence verification module, configured to verify the leading session based on the at least one piece of evidence and obtain a fraud parameter.

In an embodiment of the present application, ranking-related evidence, user rating-related evidence, user comment-related evidence, and leading user credibility-related evidence are extracted. Embodiments in which the ranking fraud detection unit 120 detects ranking fraud based on the four kinds of evidence in the present application are introduced below separately.

### (1) Ranking-Related Evidence

As one leading session may comprise one or more leading events, in order to extract evidence used to detect ranking fraud in the leading session, as an exemplary embodiment of the present application, the ranking fraud detection unit 120 may further comprise a leading event analysis module, configured to analyze some basic ranking characteristics of each leading event in the leading session, for example, identify a raising phase, a maintaining phase, and a recession phase of the leading event. In an exemplary embodiment of the present application, the manner in which the leading event analysis module identifies the three phases is: determining the first date and the last date of a ranking of the application in a peak range ΔR in the leading event, identifying a time period between the first date and the last date as the maintaining phase, identifying a time period before the maintaining phase in the leading event as the raising phase, and identifying a time period after the maintaining phase in the leading event as the recession phase.

In an exemplary embodiment, ranking-related evidence may be formed based on some ranking characteristics reflected by the raising phase and/or the recession phase in the leading event in the leading session, and an evidence value is calculated based on the formed evidence, as a fraud parameter used to determine ranking fraud. In another exemplary embodiment, ranking-related evidence may be formed based on some ranking characteristics reflected by the maintaining phase in the leading event in the leading session, and an evidence value is calculated based on the formed evidence, as a fraud parameter used to determine ranking fraud. In another exemplary embodiment, ranking-related evidence may be formed based on the number of leading events in the leading session, and the number |Eₛ| of leading events in the leading session is determined based on the formed evidence, as a fraud parameter used to determine ranking fraud.

### (2) User Rating-Related Evidence

In an exemplary embodiment, user rating-related evidence may be formed based on an average user rating R̅ₛ and a historical average rating R̅ₐ in the leading session, and an evidence value is calculated based on the formed evidence, as a fraud parameter used to determine ranking fraud. In another exemplary embodiment, user rating-related evidence may be formed based on distribution of a rating level of the application in the leading session and distribution of a rating level in historical rating information, and an evidence value is calculated based on the formed evidence, as a fraud parameter used to determine ranking fraud.

### (3) User Comment-Related Evidence

In an exemplary embodiment, user comment-related evidence may be formed based on a similarity between user comments in the leading session, and an evidence value is calculated based on the formed evidence, as a fraud parameter used to determine ranking fraud. In another exemplary embodiment, user comment-related evidence may be formed based on theme distribution of a user comment of the application in the leading session and theme distribution of a user comment in historical comment information, and an evidence value is calculated based on the formed evidence, as a fraud parameter used to determine ranking fraud.

### (4) Leading User Credibility-Related Evidence

In an exemplary embodiment, leading user credibility-related evidence may be formed based on leading user average credibility Q̅ₛ of the application and historical user average credibility Q̅ₐ of the application, and an evidence value is calculated based on the formed evidence, as a fraud parameter used to determine ranking fraud. In another exemplary embodiment, leading user credibility-related evidence may be formed based on leading user average credibility Q̅ₛ of the application and historical user average credibility Q̅ of all applications on an application leaderboard, and an evidence value is calculated based on the formed evidence, as a fraud parameter used to determine ranking fraud. In another exemplary embodiment, leading user credibility-related evidence may be formed based on distribution of leading user credibility of the application and distribution of historical user credibility of the application, and an evidence value is calculated based on the formed evidence, as a fraud parameter used to determine ranking fraud. In another exemplary embodiment, leading user credibility-related evidence may be formed based on distribution of leading user credibility of the application and distribution of historical user credibility of all applications on an application leaderboard, and an evidence value is calculated based on the formed evidence, as a fraud parameter used to determine ranking fraud.

In addition to individually using one piece of the various kinds of evidence and various types of evidence in each kind to detect ranking fraud in the foregoing exemplary embodiments, the evidence verification module may further consider a plurality of pieces of the evidence comprehensively, and weight corresponding fraud parameters obtained through verification based on the evidence, so as to obtain an ultimate fraud parameter.

In order to make those skilled in the art detect ranking fraud more conveniently, in an exemplary embodiment, the ranking fraud detection unit 120 may further comprise a fraud parameter determining module, configured to compare the fraud parameter obtained through calculation with a threshold according to the evidence, so as to intuitively determine whether ranking fraud exists in the application.

After the ranking fraud detection result is obtained in the ranking fraud detection step, in an exemplary embodiment of the present application, the ranking fraud detection system 100 further comprises a ranking fraud detection result sending unit, configured to send the obtained ranking fraud detection result to an application store operator or an application terminal user.

Those skilled in the art can understand that, in a case in which information of the leading event and information of the leading session of the application are known, those skilled in the art can directly implement the ranking fraud detection step according to the information of leading event and the information of the leading session, so as to detect application ranking fraud. Therefore, in another embodiment of the present application, a ranking fraud detection method for an application is further provided, wherein the method comprises: detecting a leading session of the application based on at least one piece of evidence, to obtain a ranking fraud detection result. In the ranking fraud detection method for an application in the embodiment, implemented technical content is identical with the ranking fraud detection step in the foregoing embodiment, which is not repeated herein.

Meanwhile, correspondingly, in another embodiment of the present application, a ranking fraud detection system for an application is further provided, wherein the system comprises: a ranking fraud detection unit, configured to detect a leading session based on at least one piece of evidence, to obtain a ranking fraud detection result. In the ranking fraud detection system for an application in the embodiment, implemented technical content is identical with the ranking fraud detection unit in the foregoing embodiment, which is not repeated herein.

FIG. 6 is a schematic structural diagram of a ranking fraud detection system 600 for an application according to an embodiment of the present application, and the specific embodiment of the present application does not limit specific implementation of the ranking fraud detection system 600. As shown in FIG. 6, the ranking fraud detection system 600 may comprise:

a processor 610, a communications interface 620, a memory 630, and a communications bus 640.

The processor 610, the communications interface 620, and the memory 630 complete mutual communications by using the communications bus 640.

The communications interface 620 is configured to communicate with a network element such as a client.

The processor 610 is configured to execute a program 632, and specifically, can implement related functions of the ranking fraud detection system in the embodiment shown in FIG. 5.

Specifically, the program 632 may comprise program code, and the program code comprises a computer operation instruction.

The processor 610 may be a central processing unit (CPU), or an application specific integrated circuit (ASIC), or be configured to be one or more integrated circuits which implement the embodiments of the present application.

The memory 630 is configured to store the program 632. The memory 630 may comprise a high-speed random access memory (RAM), and may also comprise a non-volatile memory, for example, at least one disk memory. The program 632 may specifically comprise: a leading session detection unit, configured to detect a leading session of the application based on historical ranking information; and

a ranking fraud detection unit, configured to detect the leading session based on at least one piece of evidence, to obtain a ranking fraud detection result.

The program 632 may also specifically comprise:

a ranking fraud detection unit, configured to detect a leading session of the application based on at least one piece of evidence, to obtain a ranking fraud detection result.

For specific implementation of each unit in the program 632, reference may be made to the corresponding unit in the embodiments above, which is not repeated herein.

Those of ordinary skill in the art can clearly understand that, for the purpose of convenient and brief description, for a specific working process of the devices and the modules described above, reference may be made to the corresponding descriptions in the foregoing apparatus embodiments.

Those of ordinary skill in the art may be aware that, in combination with the examples described in the embodiments disclosed in this specification, units and method steps may be implemented by electronic hardware or a combination of computer software and electronic hardware. Whether the functions are performed by hardware or software depends on particular applications and design constraint conditions of the technical solutions. Those skilled in the art may use different methods to implement the described functions for each particular application, but it should not be considered that the implementation goes beyond the scope of the present application.

When the functions are implemented in a form of a software functional unit and sold or used as an independent product, the functions may be stored in a computer-readable storage medium. Based on such an understanding, the technical solutions of the present application essentially, or the part contributing to the prior art, or a part of the technical solutions may be implemented in a form of a software product. The computer software product is stored in a storage medium, and comprises several instructions for instructing a computer device (which may be a personal computer, a server, a network device, or the like) to perform all or a part of the steps of the methods described in the embodiments of the present application. The foregoing storage medium comprises: any medium that can store program code, such as a USB flash drive, a removable hard disk, a read-only memory (ROM, Read-Only Memory), a RAM, a magnetic disk, or an optical disc.

The foregoing embodiments are merely intended for describing the present application rather than limiting the present application, and those of ordinary skill in related technical field can make various changes and variations without departing from the spirit and scope of the present application. Therefore, all equivalent technical solutions fall in the scope of the present application, and the patent protection scope of the present application shall be subject to the claims.

1. A method, comprising:
detecting, by a device comprising a processor, a leading session of an application based on historical ranking information; and
detecting the leading session based on at least one piece of evidence to obtain a ranking fraud detection result.

2. The method of claim 1, wherein the detecting the leading session based on the at least one piece of evidence comprises:
verifying the leading session based on the at least one piece of evidence and obtaining a fraud parameter.

3. The method of claim 2, wherein detecting the leading session based on the at least one piece of evidence further comprises:
identifying a raising phase, a maintaining phase, and a recession phase of at least one leading event in the leading session.

4. The method of claim 3, wherein the identifying comprises determining a first date and a last date of a ranking of the application in a peak range in the leading event, identifying a first time period between the first date and the last date as the maintaining phase, identifying a second time period before the maintaining phase in the leading event as the raising phase, and identifying a third time period after the maintaining phase in the leading event as the recession phase.

5. The method of claim 3, further comprising forming the at least one piece of evidence based on at least one of the raising phase or the recession phase in the leading event in the leading session.

6. The method of claim 5, wherein
the fraud parameter is a first average value of first date ranges of raising phases of all leading events in the leading session, or a second average value of second date ranges of recession phases of all leading events in the leading session, or a third average value of a sum of the first date ranges of the raising phases and the second date ranges of the recession phases of all leading events in the leading session.

7. The method of claim 5, wherein
the fraud parameter is a first average angle value of acute angles formed by an intersection of curves of raising phases of all leading events in the leading session and a date axis, or a second average angle value of acute angles formed by an intersection of curves of recession phases of all leading events and the date axis, or a third average value of an angle sum of acute angles formed by the intersection of the curves of the raising phases as well as the intersection of the curves of the recession phases of all leading events and the date axis.

8. The method of claim 3, wherein
the at least one piece of evidence is formed based on the maintaining phase in the leading event in the leading session.

9. The method of claim 8, wherein
the fraud parameter is an average value of date ranges of maintaining phases of all leading events in the leading session.

10. The method of claim 9, wherein
the fraud parameter is calculated based on an average ranking of the application in the maintaining phases of all leading events and the date ranges of the maintaining phases.

11. The method of claim 2, further comprising:
forming the at least one piece of evidence based on a number of leading events in the leading session.

12. The method of claim 11, wherein
the fraud parameter is the number of leading events in the leading session.

13. The method of claim 2, further comprising:
forming the at least one piece of evidence based on an average rating and a historical average rating in the leading session.

14. The method of claim 13, wherein
the fraud parameter is a difference between the average rating and the historical average rating in the leading session or a ratio of the average rating to the historical average rating.

15. The method of claim 13, wherein
the fraud parameter is another ratio of the difference between the average rating and the historical average rating in the leading session to the historical average rating.

16. The method of claim 2, further comprising:
forming the at least one piece of evidence based on a distribution of a first rating level of the application in the leading session and a distribution of a second rating level in historical rating information.

17. The method of claim 16, wherein
the fraud parameter is a difference between the distribution of the first rating level of the application in the leading session and the distribution of the second rating level in the historical rating information.

18. The method of claim 17, further comprising:
determining the difference between the distribution of the first rating level of the application in the leading session and the distribution of the second rating level in the historical rating information comprising calculating a cosine distance between the distribution of the first rating level of the application in the leading session and the distribution of the second rating level in the historical rating information.

19. The method of claim 2, further comprising:
forming the at least one piece of evidence based on a similarity determined between user comments in the leading session.

20. The method of claim 19, wherein
the fraud parameter is an average similarity determined between the user comments in the leading session.

21. The method of claim 20, wherein
the verifying the leading session further comprises:
based on processing each user comment in the leading session according to a set of defined rules, constructing a vocabulary vector for each user comment in the leading session; and
determining the average similarity between the user comments in the leading session based on the vocabulary vector for each user comment.

22. The method of claim 2, wherein
the at least one piece of evidence is formed based on a first theme distribution of a first user comment of the application in the leading session and a second theme distribution of a second user comment in historical comment information.

23. The method of claim 22, wherein
the fraud parameter is a difference between the first theme distribution of the first user comment of the application in the leading session and the second theme distribution of the second user comment in the historical comment information.

24. The method of claim 23, further comprising:
determining the difference between the first theme distribution of the first user comment of the application in the leading session and the second theme distribution of the second user comment in the historical comment information comprising calculating a cosine distance between the first theme distribution of the first user comment of the application in the leading session and the second theme distribution of the second user comment in the historical comment information.

25. The method of claim 2, wherein the at least one piece of evidence is formed based on a first value representing a leading user average credibility of the application and a second value representing a historical user average credibility of the application.

26. The method of claim 25, wherein
the fraud parameter is a difference between the second value representing the historical user average credibility of the application and the first value representing the leading user average credibility of the application or a ratio of the second value representing the historical user average credibility of the application to the first value representing the leading user average credibility of the application.

27. The method of claim 2, wherein the at least one piece of evidence is formed based on a first value representing a leading user average credibility of the application and a second value representing a historical user average credibility of all applications on an application leaderboard.

28. The method of claim 27, wherein
the fraud parameter is a difference between the second value representing the historical user average credibility of all the applications on the application leaderboard and the first value representing the leading user average credibility of the application or a ratio of the second value representing the historical user average credibility of all the applications on the application leaderboard to the first value representing the leading user average credibility of the application.

29. The method of claim 2, wherein
the at least one piece of evidence is formed based on a first distribution of a leading user credibility of the application and a second distribution of a historical user credibility of the application.

30. The method of claim 29, wherein
the fraud parameter is a difference between the second distribution of the historical user credibility of the application and the first distribution of the leading user credibility of the application.

31. The method of claim 30, further comprising:
determining the difference between the second distribution of the historical user credibility of the application and the first distribution of the leading user credibility of the application comprising calculating a cosine distance between the second distribution of the historical user credibility of the application and the first distribution of the leading user credibility of the application.

32. The method of claim 2, wherein
the at least one piece of evidence is formed based on a first distribution of leading user credibility of the application and a second distribution of historical user credibility of all applications on an application leaderboard.

33. The method of claim 32, wherein
the fraud parameter is a difference between the second distribution of the historical user credibility of all the applications on the application leaderboard and the first distribution of the leading user credibility of the application.

34. The method of claim 33, wherein the difference between the second distribution of the historical user credibility of all the applications on the application leaderboard and the first distribution of the leading user credibility of the application is calculated by calculating a cosine distance between the second distribution of the historical user credibility of all the applications on the application leaderboard and the first distribution of the leading user credibility of the application.

35. The method of claim 2, wherein, in the verifying the leading session, the at least one piece of evidence is considered according to respective entireties, and corresponding fraud parameters obtained through verification based on the at least one piece of evidence are weighted as part of obtaining the fraud parameter.

36. The method of any one of claim 2, wherein the detecting the leading session based on the at least one piece of evidence comprises:
comparing the fraud parameter with a threshold to determine whether ranking fraud exists in the application as a result of whether the fraud parameter satisfies a defined function with respect to the threshold.

37. The method of claim 1, further comprising:
acquiring the historical ranking information of the application from an application leaderboard.

38. The method of claim 37, wherein the acquiring the historical ranking information comprises acquiring the historical ranking information from an application store operator, or extracting the historical ranking information from data accessible via an application store.

39. The method of claim 1, wherein the historical ranking information comprises a ranking index corresponding to a discrete date index, and each element in the ranking index corresponds to one discrete date point in the discrete date index, indicating a ranking of the application in the one discrete date point.

40. The method of claim 1, wherein the historical ranking information comprises rating information received from an application user to the application in each historical time period.

41. The method of claim 1, wherein the historical ranking information comprises a user comment received from an application user to the application in each historical time period.

42. The method of claim 1, wherein the historical ranking information comprises user credibility of the application in each historical time period or user credibility of all applications on an application leaderboard in each historical time period.

43. The method of claim 1, further comprising:
sending the leading session of the application to at least one device of an application developer, an application store operator, or an application user.

44. The method of claim 1, further comprising:
sending the ranking fraud detection result to at least one device of an application store operator or an application user.

45. A system, comprising:
a memory that stores executable units; and
a processor, coupled to the memory, that executes the executable units to perform operations of the system, the executable units comprising:
a leading session detection unit configured to detect a leading session of an application based on historical ranking information; and
a ranking fraud detection unit configured to detect the leading session based on at least one piece of evidence to obtain a ranking fraud detection result.

46. The system of claim 45, wherein the ranking fraud detection unit further comprises:
an evidence verification module configured to verify the leading session based on the at least one piece of evidence and obtain a fraud parameter.

47. The system of claim 46, wherein the ranking fraud detection unit further comprises:
a leading event analysis module configured to identify a raising phase, a maintaining phase, and a recession phase of at least one leading event in the leading session.

48. The system of claim 47, wherein the leading event analysis module is configured to determine a first date and a last date of a ranking of the application in a peak range in the leading event, identify a first time period between the first date and the last date as the maintaining phase, identify a second time period before the maintaining phase in the leading event as the raising phase, and identify a third time period after the maintaining phase in the leading event as the recession phase.

49. The system of claim 47, wherein the at least one piece of evidence is formed based on the raising phase or the recession phase in the leading event in the leading session.

50. The system of claim 47, wherein the at least one piece of evidence is formed based on the maintaining phase in the leading event in the leading session.

51. The system of claim 46, wherein the at least one piece of evidence is formed based on a number of leading events in the leading session.

52. The system of claim 46, wherein the at least one piece of evidence is formed based on an average rating and a historical average rating in the leading session.

53. The system of claim 46, wherein the at least one piece of evidence is formed based on a distribution of a first rating level of the application in the leading session and distribution of a second rating level in historical rating information.

54. The system of claim 46, wherein the at least one piece of evidence is formed based on a similarity between user comments in the leading session.

55. The system of claim 46, wherein the at least one piece of evidence is formed based on a first theme distribution of a first user comment of the application in the leading session and a second theme distribution of a second user comment in historical comment information.

56. The system of claim 46, wherein the at least one piece of evidence is formed based on first credibility data representing a leading user average credibility of the application and second credibility data representing a historical user average credibility of the application.

57. The system of claim 46, wherein the at least one piece of evidence is formed based on first credibility data representing a leading user average credibility of the application and second credibility data representing historical user average credibilities of all applications on an application leaderboard.

58. The system of claim 46, wherein the at least one piece of evidence is formed based on a first distribution of leading user credibility of the application and a second distribution of historical user credibility of the application.

59. The system of claim 46, wherein the at least one piece of evidence is formed based on a first distribution of leading user credibility of the application and a second distribution of historical user credibilities of all applications on an application leaderboard.

60. The system of claim 46, wherein the evidence verification module is configured to consider the at least one piece of evidence comprehensively, and weight corresponding fraud parameters obtained through verification based on the at least one piece of evidence, to obtain the fraud parameter.

61. The system of claim 46, wherein the ranking fraud detection unit further comprises:
a fraud parameter determining module configured to compare the fraud parameter with a threshold, to determine whether ranking fraud exists in the application.

62. The system of claim 45, wherein the executable units further comprise:
a historical ranking information acquisition unit configured to acquire the historical ranking information of the application on an application leaderboard.

63. The system of claim 62, wherein the historical ranking information acquisition unit is configured to acquire the historical ranking information from an application store operator, or extract the historical ranking information from data released by an application store.

64. The system of claim 45, wherein the executable units further comprise a leading session sending unit configured to send the leading session of the application to at least one device associated with an application developer, an application store operator, or an application user.

65. The system of claim 45, wherein the executable units further comprise a ranking fraud detection result sending unit configured to send the ranking fraud detection result to at least one device associated with an application store operator or an application user.

66. A method, comprising:
detecting, by a device comprising a processor, a leading session of an application based on at least one piece of evidence, to obtain a ranking fraud detection result.

67. The method of claim 66, further comprising:
verifying the leading session based on the at least one piece of evidence and obtaining a fraud parameter.

68. The method of claim 67, further comprising:
identifying a raising phase, a maintaining phase, and a recession phase of at least one leading event in the leading session.

69. The method of claim 68, wherein a first date and a last date of a ranking of the application in a peak range in the leading event is determined, a first time period between the first date and the last date is identified as the maintaining phase, a second time period before the maintaining phase in the leading event is identified as the raising phase, and a third time period after the maintaining phase in the leading event is identified as the recession phase.

70. The method of claim 68, wherein the at least one piece of evidence is formed based on the raising phase or the recession phase in the leading event in the leading session.

71. The method of claim 70, wherein
the fraud parameter is a first average value of first date ranges of raising phases of all leading events in the leading session, or a second average value of second date ranges of recession phases of all leading events in the leading session, or a third average value of a sum of the first date ranges of the raising phases and the second date ranges of the recession phases of all leading events in the leading session.

72. The method of claim 70, wherein
the fraud parameter is a first average angle value of acute angles formed by a first intersection of first curves of raising phases of all leading events in the leading session and a date axis, or a second average angle value of acute angles formed by a second intersection of second curves of recession phases of all leading events and the date axis, or a third average value of an angle sum of acute angles formed by the first intersection of the first curves of the raising phases and the second intersection of the second curves of the recession phases of all leading events, and the date axis.

73. The method of claim 68, wherein
the at least one piece of evidence is formed based on the maintaining phase in the leading event in the leading session.

74. The method of claim 73, wherein
the fraud parameter is an average value of date ranges of maintaining phases of all leading events in the leading session.

75. The method of claim 73, wherein the fraud parameter is calculated based on an average ranking of the application in maintaining phases of all leading events and date ranges of the maintaining phases.

76. The method of claim 67, wherein
the at least one piece of evidence is formed based on a number of leading events in the leading session.

77. The method of claim 76, wherein
the fraud parameter is the number of leading events in the leading session.

78. The method of claim 67, wherein the at least one piece of evidence is formed based on an average rating and a historical average rating in the leading session.

79. The method of claim 78, wherein
the fraud parameter is a difference or a ratio between the average rating and the historical average rating in the leading session.

80. The method of claim 78, wherein
the fraud parameter is a ratio of a difference between the average rating and the historical average rating in the leading session to the historical average rating.

81. The method of claim 67, wherein
the at least one piece of evidence is formed based on a first distribution of a first rating level of the application in the leading session and a second distribution of a second rating level in historical rating information.

82. The method of claim 81, wherein
the fraud parameter is a difference between the first distribution of the first rating level of the application in the leading session and the second distribution of the second rating level in the historical rating information.

83. The method of claim 82, wherein the difference between the first distribution of the first rating level of the application in the leading session and the second distribution of the second rating level in the historical rating information is calculated by calculating a cosine distance between the first distribution of the first rating level of the application in the leading session and the second distribution of the second rating level in the historical rating information.

84. The method of claim 67, wherein the at least one piece of evidence is formed based on a similarity between user comments in the leading session.

85. The method of claim 84, wherein
the fraud parameter is an average similarity between the user comments in the leading session.

86. The method of claim 85, wherein
the verifying the leading session further comprises:
performing standardized processing on each user comment in the leading session;
constructing respective standardized vocabulary vectors for each user comment in the leading session; and
calculating the average similarity between each user comment in the leading session based on the respective standardized vocabulary vectors.

87. The method of claim 67, wherein
the at least one piece of evidence is formed based on a first theme distribution of a first user comment of the application in the leading session and a second theme distribution of a second user comment in historical comment information.

88. The method of claim 87, wherein
the fraud parameter is a difference between the first theme distribution of the first user comment of the application in the leading session and the second theme distribution of the second user comment in the historical comment information.

89. The method of claim 88, wherein the difference between the first theme distribution of the first user comment of the application in the leading session and the second theme distribution of the second user comment in the historical comment information is calculated by calculating a cosine distance between the first theme distribution of the first user comment of the application in the leading session and the second theme distribution of the second user comment in the historical comment information.

90. The method of claim 67, wherein the at least one piece of evidence is formed based on a leading user average credibility of the application and a historical user average credibility of the application.

91. The method of claim 90, wherein
the fraud parameter is a difference or a ratio between the historical user average credibility of the application and the leading user average credibility of the application.

92. The method of claim 67, wherein the at least one piece of evidence is formed based on a leading user average credibility of the application and historical user average credibilities of all applications on an application leaderboard.

93. The method of claim 92, wherein
the fraud parameter is a difference or a ratio between the historical user average credibilities of all the applications on the application leaderboard and the leading user average credibility of the application.

94. The method of claim 67, wherein
the at least one piece of evidence is formed based on a first distribution of a leading user credibility of the application and a second distribution of a historical user credibility of the application.

95. The method of claim 94, wherein
the fraud parameter is a difference between the second distribution of the historical user credibility of the application and the first distribution of the leading user credibility of the application.

96. The method of claim 95, wherein the difference between the second distribution of the historical user credibility of the application and the first distribution of the leading user credibility of the application is calculated by calculating a cosine distance between the second distribution of the historical user credibility of the application and the first distribution of the leading user credibility of the application.

97. The method of claim 67, wherein
the at least one piece of evidence is formed based on a first distribution of a leading user credibility of the application and a second distribution of historical user credibilities of all applications on an application leaderboard.

98. The method of claim 97, wherein
the fraud parameter is a difference between the second distribution of the historical user credibilities of all the applications on the application leaderboard and the first distribution of the leading user credibility of the application.

99. The method of claim 98, wherein the difference between the second distribution of the historical user credibilities of all the applications on the application leaderboard and the first distribution of the leading user credibility of the application is calculated by calculating a cosine distance between the second distribution of the historical user credibilities of all the applications on the application leaderboard and the first distribution of the leading user credibility of the application.

100. The method of claim 67, wherein, in the verifying the leading session, the at least one piece of evidence is considered comprehensively, and corresponding fraud parameters obtained through verification based on the at least one piece of evidence are weighted, so as to obtain the fraud parameter.

101. The method of claim 67, further comprising:
comparing the fraud parameter with a threshold, so as to determine whether ranking fraud exists in the application.

102. The method of claim 66, further comprising: sending the ranking fraud detection result to at least one address associated with an application store operator or an application user.

103. A system, comprising:
a memory that stores executable units; and
a processor, coupled to the memory, that executes the executable units to perform operations of the system, the executable units comprising:
a ranking fraud detection unit configured to detect a leading session of an application based on at least one piece of evidence to obtain a ranking fraud detection result.

104. The system of claim 103, wherein the ranking fraud detection unit further comprises:
an evidence verification module configured to verify the leading session based on the at least one piece of evidence and obtain a fraud parameter.

105. The system of claim 104, wherein the ranking fraud detection unit further comprises:
a leading event analysis module configured to identify a raising phase, a maintaining phase, and a recession phase of at least one leading event in the leading session.

106. The system of claim 105, wherein the leading event analysis module is configured to determine a first date and a last date of a ranking of the application in a peak range in the leading event, identify a first time period between the first date and the last date as the maintaining phase, identify a second time period before the maintaining phase in the leading event as the raising phase, and identify a third time period after the maintaining phase in the leading event as the recession phase.

107. The system of claim 105, wherein the at least one piece of evidence is formed based on the raising phase or the recession phase in the leading event in the leading session.

108. The system of claim 105, wherein the at least one piece of evidence is formed based on the maintaining phase in the leading event in the leading session.

109. The system of claim 104, wherein the at least one piece of evidence is formed based on a number of leading events in the leading session.

110. The system of claim 104, wherein the at least one piece of evidence is formed based on an average rating and a historical average rating in the leading session.

111. The system of claim 104, wherein the at least one piece of evidence is formed based on a first distribution of a first rating level of the application in the leading session and a second distribution of a second rating level in historical rating information.

112. The system of claim 104, wherein the at least one piece of evidence is formed based on a similarity between user comments in the leading session.

113. The system of claim 104, wherein the at least one piece of evidence is formed based on a first theme distribution of a first user comment of the application in the leading session and a second theme distribution of a second user comment in historical comment information.

114. The system of claim 104, wherein the at least one piece of evidence is formed based on a leading user average credibility of the application and a historical user average credibility of the application.

115. The system of claim 104, wherein the at least one piece of evidence is formed based on a leading user average credibility of the application and historical user average credibilities of all applications on an application leaderboard.

116. The system of claim 104, wherein the at least one piece of evidence is formed based on a first distribution of a leading user credibility of the application and a second distribution of a historical user credibility of the application.

117. The system of claim 104, wherein the at least one piece of evidence is formed based on a first distribution of a leading user credibility of the application and a second distribution of historical user credibilities of all applications on an application leaderboard.

118. The system of claim 104, wherein the evidence verification module is configured to consider the at least one piece of evidence entirely, and weight corresponding fraud parameters obtained through verification based on the at least one piece of evidence, resulting in weighted fraud parameter used to obtain the fraud parameter.

119. The system of claim 104, wherein the ranking fraud detection unit further comprises:
a fraud parameter determining module configured to compare the fraud parameter with a threshold, to determine whether ranking fraud exists in the application.

120. The system of claim 103, wherein the executable units further comprise a ranking fraud detection result sending unit configured to send the ranking fraud detection result to at least one device of an application store operator or an application user.

121. A computer readable storage device, comprising at least one executable instruction, which, in response to execution, causes a system comprising a processor to perform operations, comprising:
detecting a leading session of the application based on historical ranking information; and
detecting the leading session based on at least one piece of evidence, to obtain a ranking fraud detection result.

122. A computer readable storage device, comprising at least one executable instruction, which, in response to execution, causes a system comprising a processor to perform operations, comprising:
detecting a leading session of the application based on at least one piece of evidence, to obtain a ranking fraud detection result.
